(19) United States
(12) Patent Application Publication
(10) Pub. No.: US 2009/0184841 A1
(43) Pub. Date: Jul. 23, 2009

(54) METHOD AND SYSTEM OF DATA ACQUISITION AND TRANSMISSION

(75) Inventor: Christopher Kim Gardiner, Western Australia (AU)

Correspondence Address: NIXON & VANDERHYE, PC, 901 NORTH GLEBE ROAD, 11TH FLOOR, ARLINGTON, VA, 22203, US

(73) Assignee: WELLDATA PTY. LTD., Bayswater, Perth, W.A. (AU)

(21) Appl. No.: 12/302,424

(22) PCT Filed: May 23, 2007
(86) PCT No.: PCT/AU2007/000705

§ 371 Date: Nov. 25, 2008

(30) Foreign Application Priority Data
May 25, 2006 (AU) 2006902829

(51) Int. Cl. G01V 3/00

(52) U.S. Cl. 340/853.1

(57) ABSTRACT

A system and method of data acquisition and transmission for use in a channel for conveying liquid and/or gas, such as a wellbore. The system includes one or more of data acquisition modules for acquiring data relating to conditions adjacent the module and transmitting the data to a terminal collection station or adjacent data acquisition module via an electromagnetic signal. Each data acquisition module is configured to transmit the signal such that an element of the channel adjacent the data acquisition module acts as a waveguide.

### FIELD OF THE INVENTION

The present invention relates to a method and system of data acquisition and transmission for use in a channel or conduit for conveying liquid and/or gas such as a wellbore, surface pipeline or subsurface pipeline. The invention relates particularly to such a method and system which is capable of providing increased data transmission rates and may be responsive to changes in. wellbore conditions to vary the rate of data acquisition and/or transmission.

### BACKGROUND OF THE INVENTION

In the oil and gas industry wellbores are drilled, for example, for the purpose of exploration and/or the production of hydrocarbon fluids from subterranean reservoirs or for the purpose of fluid or gas injection and for effluent disposal. The fluids in such reservoirs are often subject to varying conditions of temperature, pressure and flow rate which can have a significant impact on the manner in which they are recovered. Therefore it is necessary to continually monitor downhole conditions so that appropriate adjustments to the production control system can be made. For this purpose, data acquisition apparatus, including a plurality of sensors, are often provided in a well bore to monitor the movement of fluid within the reservoir, wellbore and flowlines connected to the wellbore.

In a wellbore that employs both casing and tubing, sensors are typically placed in the annulus between casing and tubing or in the tubing. The sensors may be connected to the surface by a cable located in the annulus, to convey both power and telemetry signals to the sensors. In some prior art systems the sensors have been deployed behind the casing, the sensors being connected to the surface by a cable which passes through the cement holding the casing in contact with the outer wall of the well bore. However problems have arisen with such techniques due to the difficulties of protecting the cable during installation, and ensuring the quality or integrity of the cement is not affected by the presence of the cable. GB 2,340,520 proposes to avoid such problems by providing a wireless telemetry link from the down hole sensors to a data collection centre on the surface.

A further problem with many prior art down hole data acquisition systems is the sheer volume of data that may be acquired in the down hole environment and that has to be transmitted to the surface. Such data may include measurements of fluid temperature, pressure, flow rate, noise, resistivity and electrical conductivity. The present invention provides increased data transmission rates using RF transmission signals by addressing the issue of signal loss in a downhole environment.

Prior use of waveguides as a data transmission device, generally in the telecommunication industry, has used air as the transmission medium within the waveguide. The present invention uses the waveguide principle in transmitting through oil, water and gas mixtures of varying proportions at both high flow rates as well as in the stationary mode.

Further, prior art systems have tended not to make any distinctions or to prioritise the data acquired downhole; instead all the data is transmitted to the surface where useful information is extracted from the non-useful data according to predetermined processing criteria. However this is wasteful of data processing and storage resources and runs the risk that significant information may not be extracted sufficiently quickly from the mass of downhole data acquired to make appropriate and timely changes to production parameters. There is thus a need for a more intelligent downhole data acquisition system capable of quickly responding to significant changes in downhole conditions. Furthermore, prior art systems have tended to rely on extra low frequency electromagnetic or acoustic wireless communication systems for transferring data, which have limited bandwidth and high power consumption.

The present invention was developed with a view to providing a method and system of downhole data acquisition using electromagnetic signals and employing the waveguide principle. The system and method typically employs an array of downhole intelligent data acquisition modules, each module being capable of varying the rate of data acquisition and/or transmission in response to changes in downhole conditions.

References to prior art in this specification are provided for illustrative purposes only and are not to be taken as an admission that such prior art is part of the common general knowledge in Australia or elsewhere.

### SUMMARY OF THE INVENTION

According to one aspect of the invention, there is provided system of data acquisition and transmission in a channel conveying a liquid and/or gas, the system comprising one or more of data acquisition modules for acquiring data relating to conditions adjacent the data acquisition module and transmitting the data to a terminal collection station or adjacent data acquisition module via an electromagnetic signal, wherein the or each data acquisition module is configured to transmit the signal such that an element of the channel adjacent the data acquisition module acts as a waveguide and each module includes a data processing means for responding to changes in conditions and for controlling the rate of data acquisition and/or transmission accordingly, whereby, in use, the volume of data to be transmitted to the terminal collection station can be optimised depending on conditions.

According to another aspect of the present invention, there is provided a method of data acquisition and transmission in a channel conveying a liquid and/or gas, the method comprising the steps of:
providing one or more of data acquisition modules for acquiring data relating to conditions adjacent the data acquisition module, the or each data acquisition module including a data processing means and being configured to transmit the signal such that an element of the channel adjacent the data acquisition module acts as a waveguide;
transmitting the data to a terminal collection station or adjacent data acquisition module via an electromagnetic signal, the data processing means responding to changes in conditions and controlling the rate of data acquisition and/or transmission depending on downhole conditions.

According to a further aspect of the invention, there is provided a data acquisition module for use in a channel conveying a liquid and/or gas, the data acquisition module comprising:
a means for acquiring data relating to the conditions adjacent the module;
a transceiver for transmitting the data to a terminal collection station or adjacent data acquisition module via an electromagnetic signal; and
a data processing means for responding to changes in conditions and for controlling the rate of data acquisition and/or transmission accordingly, whereby, in use, the volume of data to be transmitted to the terminal collection station can be optimised depending on downhole conditions;
wherein the data acquisition module is configured to transmit the signal such that an element of the channel adjacent the data acquisition module acts as a waveguide.

The element of the channel acting as a waveguide may comprise a wellbore liner, an annular space between the wellbore liner and a tubing or a control line. Preferably the electromagnetic signal comprises an RF or microwave signal.

Preferably, the rate of data transmitted may be adjusted according to the rate of change of the acquired data.

Advantageously, each of the data acquisition modules combines data acquired by that data acquisition module with data received from other data acquisition modules and transmits the combined data to the terminal collection station directly or indirectly via other data acquisition modules. The data acquisition modules may also-perform calculations on the data received from a plurality of data acquisition modules and transmits the results of the calculations to the terminal collection station directly or indirectly.

Preferably, the frequency of the transmitted signal is tuned based on the properties of the fluid through which the signal is transmitted.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the method and system of data acquisition and transmission, given by way of example only, with reference to the accompanying drawings, in which:

FIG. 1 shows a conventional wellbore with three production zones;

FIG. 2 shows the wellbore of FIG. 1 in which enhanced. oil recovery using gas injection is to commence, under the control of a first embodiment of the method and system of data acquisition and transmission in accordance with the invention;

FIG. 3 is a schematic diagram of a typical embodiment of an intelligent data acquisition module employed in the method and system of data acquisition and transmission illustrated in FIG. 2;

FIG. 4 shows a conventional wellbore with an open formation in which a second embodiment of the method and system of data acquisition and transmission in accordance with the invention is employed;

FIG. 5 illustrates schematically an embodiment of one manner of interconnecting two modules in a system of data acquisition and transmission according to the present invention using a control line; and,

FIG. 6 illustrates schematically an embodiment of a data acquisition module according to the invention housed in a sub.

### DETAILED DESCRIPTION OF PREFERRED EMBODIMENTS

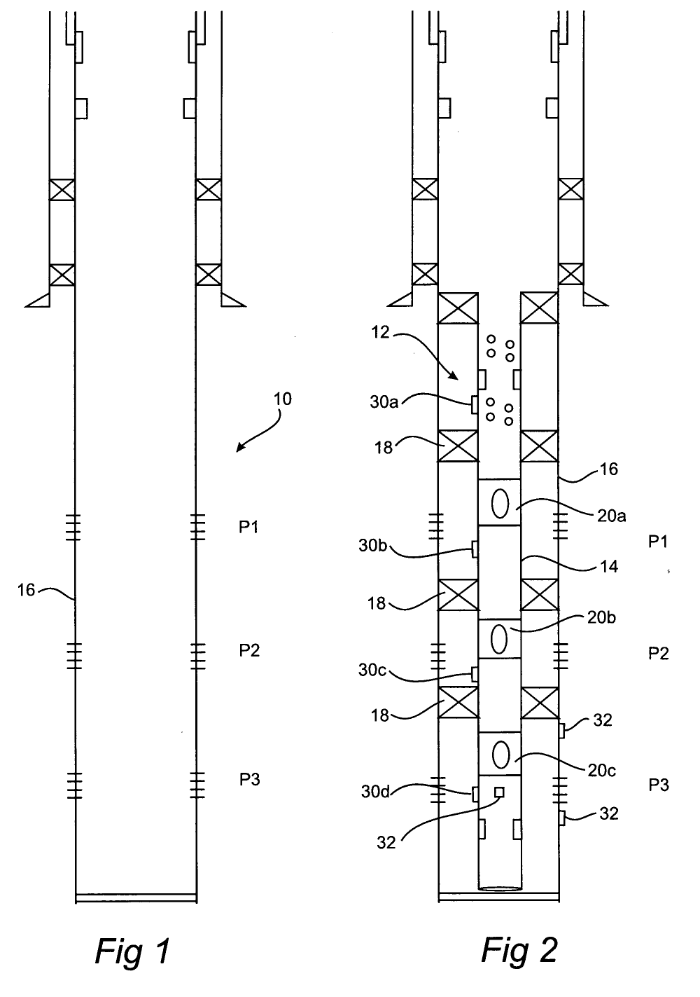

A preferred embodiment of the method and system of data acquisition in accordance with the invention will now be described with reference to FIGS. 1 and 2 of the accompanying drawings. The method and system are to be employed in a channel for conveying a liquid and/or gas. In the embodiment to be described, the channel comprises a wellbore. FIG. 1 is a schematic drawing of a conventional wellbore 10 in which primary recovery of oil has ceased and enhanced oil recovery using gas injection is to commence. Gas injection involves injecting a gas such as natural gas, nitrogen, or carbon dioxide into a wellbore in order to increase pressure in a reservoir so as to push additional oil to a production wellbore. In the wellbore 10 of FIG. 1 three production zones are identified as P1 (upper zone), P2 (middle zone),and P3 (lower zone) respectively. In order to proceed with gas injection a flow control system must be retrofitted in the wellbore 10 to control the flow of gas into each of the production zones.

FIG. 2 illustrates schematically a retrofit installation of a flow control system 12 in the wellbore 10 for injecting gas into each of the production zones. The gas injection flow control system 12 incorporates one possible embodiment of the method and system of data acquisition in accordance with the invention. The flow control system 12 comprises a tubing string 14 which is supported in an existing wellbore liner 16 by a series of thru tree packers 18 located at spaced intervals in the liner 16. Adjacent to each of the production zones P1, P2 and P3 the tubing 14 is provided with a respective gas injection opening that may be opened and closed using a respective adjustable valve device 20a, 20b and 20c. Each of the adjustable valve devices 20 may be in the form of a wireless controlled sliding sleeve device or variable choke.

In order to provide intelligent management of the gas injection via the flow control system 12, an array of intelligent data acquisition modules 30 is deployed in the wellbore 10 in accordance with a preferred embodiment of the present invention. The data acquisition modules 30 of the invention may be deployed either initially into the wellbore or may be fitted retrospectively. Each of the data acquisition modules 30 is designed for intelligently acquiring data relating to downhole conditions and transmitting the data to a terminal collection station (not illustrated). In this embodiment four modules 30a, 30b, 30c and 30d are illustrated mounted at spaced intervals on the liner 16 in the wellbore. Three of the modules 30b, 30c and 30d are mounted in close proximity to the adjustable valve devices 20a, 20b and 20c respectively and the corresponding production zones P1, P2 and P3.

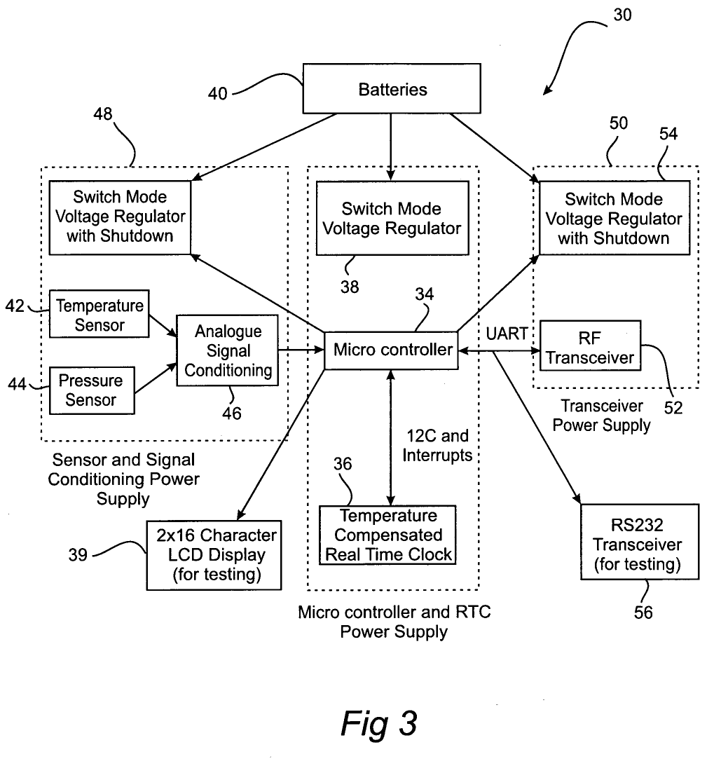

Each of the data acquisition modules 30 comprises a data processing means for intelligently responding to changes in downhole conditions and for controlling the rate of data acquisition and/or transmission accordingly, and a data transceiver for receiving data from, and transmitting data to, other modules 30 in the array and/or the terminal collection station. The components of a typical data acquisition module 30 will be described in greater below with reference to FIG. 3. The modules 30 are preferably capable of communicating wirelessly with a respective valve device 20, for controlling the opening and closing of the gas injection openings into each of the production zones. Alternatively the valve devices 20 may be hardwired to a respective data acquisition module 30.

Each of the data acquisition modules 30 is capable of communicating wirelessly with other modules 30 in the array and/or the terminal collection station. The wireless communication is via an electromagnetic transmission signal that is constrained within, an existing tubular element of the channel for conveying liquid and/or gas using the waveguide principle. Preferably, the communication is via an RF signal constrained within the downhole metal wellbore liner 16, the annular space between the wellbore liner 16 and the tubing 14, or a control line (not shown). That is an RF signal having characteristics determined by the physical characteristics of the wellbore liner 16 such that the wellbore liner 16 acts as a waveguide, thereby reducing transmission loss.

Each of the data acquisition modules 30 may be configured differently for transmission of signals based on the characteristics of the element of the channel being used as a waveguide. For example, should the wellbore liner 16 be used as a waveguide, if the dimensions of the wellbore liner 16 differ at various locations throughout the well, the data acquisition modules 30 may be configured to transmit at different frequencies related to the local dimensions of the wellbore liner 16 to improve transmission.

The transceivers, data processing means and associated electronics have all been designed for minimum power consumption whilst operating. After signal transmission, sleep modes are induced to further reduce the power consumption until the following transmission is required. Typical power consumption is of the order of 0.1 mW/hr. Typically data is transmitted from the transceiver in one module 30 to the transceiver in an adjacent partner module 30 in a daisy chain fashion. The spacing between transceivers is such that under normal operating conditions, each transceiver can communicate directly to its partner and its partners' adjacent transceiver, providing an extra backup facility and level of redundancy.

Preferably a plurality of downhole sensors 32 are also deployed for sensing downhole conditions in the region of the respective production zones P1, P2 and P3. Each of the sensors 32 is preferably hardwired to an associated data acquisition module 30 which receives and processes the data acquired from the sensors 32. The sensors 32 may be designed to sense a variety of wellbore parameters including, for example, temperature, pressure, flow rate, noise, resistivity and electrical conductivity. Typically gas will be injected into only one of the production zones P at a time. For illustrative purposes it is assumed that gas is being injected into the lower production zone P3, and therefore the valve devices 20a and 20b will be closed. Sensors 32 associated with data acquisition module 30d sense the temperature, pressure and flow rate of gas being injected into the production zone P3 and this sensed data is processed by the data processing means in module 30d.

The data processing means in the module 30d may be programmed to process the sensed data according to a particular algorithm and to transmit the results of this processing to an adjacent module 30c at predetermined timed intervals. The adjacent module 30c then combines this data with its own acquired and processed data (if any) and passes this information on to the next module 30b. In this way the acquired data may be transmitted all the way back to the terminal collection station. However not all of the acquired data is necessarily transmitted back to the terminal collection station. Each of the modules has sufficient onboard intelligence so that it can be programmed to decide when and under what circumstances data should be transmitted to the terminal collection station.

The data processing means may be programmed to convert the raw data into more meaningful information prior to transmission to the surface. Thus, for example, the raw data for the changes in a particular parameter over a fixed period may be converted into the form of a polynomial defining the shape of the curve. Furthermore if a module 30 detects a significant change in the sensed parameters it can modify the rate of data acquisition and transmission so as to minimise power consumption during quiescent periods. Preferably the rate of change in sensed parameters is constantly monitored so that the rate of data acquisition can be adjusted accordingly. Hence if the rate of change in a particular sensed parameter increases the rate of data acquisition will also increase in an intelligent fashion to capture all relevant data. On the other hand if the rate of change in a particular sensed parameter decreases, the rate of data acquisition may also be decreased in order to conserve power and minimise data storage and transmission requirements.

Based on the data received from the data acquisition modules 30 the terminal collection station (not illustrated) may modulate the opening and closing of the valve device 20c, in order to control the flow of gas injected into the production zone P3. Appropriate control signals are transmitted to the module 30d which then opens the valve device 20c accordingly. Alternatively, the data acquisition module 30d may be programmed to make such decisions and control the opening and closing of the valve device 20c based on its own analysis of the data acquired from the downhole sensors 32.

A preferred embodiment of the data acquisition module 30 will now be described in more detail with reference to FIG. 3. The illustrated module was designed for testing purposes, however a module deployed in the field would have a similar configuration. The heart of the intelligent data acquisition module 30 is the data processing means, which comprises a microcontroller 34, a temperature compensated real time clock 36 and a switch mode voltage regulator 38 for supplying power to the microcontroller 34 and clock 36 from a battery power pack 40. For the purposes of visual feedback during testing a Liquid Crystal Display (LCD) 39 is provided in connection with the microcontroller 34.

One or more downhole sensors 32 (or other downhole devices) are operatively coupled to the microcontroller 34. In the illustrated embodiment a temperature sensor 42 and pressure sensor 44 are connected to the microcontroller 34 via an analogue signal conditioning circuit 46. The analogue signal conditioning circuit 46 provides analogue to digital conversion of the analogue signals from the sensors 42 and 44 before passing them on to the microcontroller 34. The sensors 42 and 44 supplied with power via a switch mode voltage regulator 48 with shutdown, in this case also connected to power pack 40 (but in the field they may have their own independent power supply).

The data acquisition unit 30 further comprises a data transceiver 50 for receiving data from, and transmitting data to, other modules in the array and/or a terminal collection station. Data transceiver 50 comprises an RF transceiver 52 with its own switch mode voltage regulator 54 with shutdown. The RF transceiver 52 is connected to the microcontroller 34 via a UART. The RF transceiver comprises an antenna (not shown in FIG. 3) which extends into the transmission medium. The antenna is typically a tuned coaxial antenna. A 2.4 GHz signal was employed, so that the wavelength of the signal in air is 125 mm. Hence for testing purposes a tuned length was chosen for the antennas. The antenna was made using a copper sealed co-axial cable, with the shielding cut off to create the transmitting part of the antenna. An RS232 transceiver 56 is also provided for testing purposes. In one embodiment the data acquisition module 30 is housed in a sub, all of the electronics being housed in a casing external to the sub and the antenna(s) extending through a wall of the sub into the production fluid (see further the description of FIG. 6 below).

Testing of a prototype data acquisition module in various fluid media flowing through a test pipe yielded the following results: With an oil flow rate of 50 m³/hour (2 m/s), at atmospheric pressure, transmission over 11 metres of pipe (in both horizontal and vertical orientations) was possible with up to approximately 3% water. Within the resolution available to these tests, gas velocity, at atmospheric pressure, appeared to have no impact on the signal. A small percentage of air in flowing oil slightly decreases the signal strength. As the percentage increases the signal strength increases-to that as it would be in pure air.

For mixtures of oil, air and water, an increase in the gas volume factor generally allowed for a greater level of water to be present (by volume percentage) before the signal was lost. With the same level of water percentage, the system performs very differently at different angles of inclination. This indicates that the manner in which the water is carried by any medium greatly influences the performance of the system. The signal was successfully transmitted the full length of the flow loop in both air and vitrea oil. The test apparatus consisted of two eleven metre straight pipe sections joined by a five metre corner section, generating a total transmission length of twenty seven metres. In pure flowing air and vitrea oil (or with low levels of water), a video signal was successfully transmitted over eleven and twenty seven metres.

Tuned antennas specifically coupled to the dielectric properties of the vitrea oil performed better in oil than the original antennas (which were designed for air). Over a distance of twenty seven meters a signal was successfully sent through an oil/water mixture with up to 0.8% water content. A signal was received regardless of antenna orientation, albeit it stronger in some directions than in others. In low flow rates of oil much higher levels of water flow were possible. Over a very short distance (100 mm) the signal was successfully transmitted in oil and water mixtures with a much higher percentage of water.

The preferred telemetry method for data communication in the data acquisition system of the invention is via channelled RF or microwave transmission providing duplex communication using the waveguide principle. This provides for significantly increased bandwidth which permits vast amounts of data to be transferred at relatively low power. More complex instructions can be transmitted to downhole devices (permitting more complex operations to be performed and even reprogramming of downhole devices) and more data can be sent up hole, facilitating improved data sample rates and data acquisition rates. Signals can be transmitted and received in horizontal and vertical well sections. This provides for much greater flexibility in the configuration of an array of downhole intelligent data acquisition modules of the system in a downhole environment.

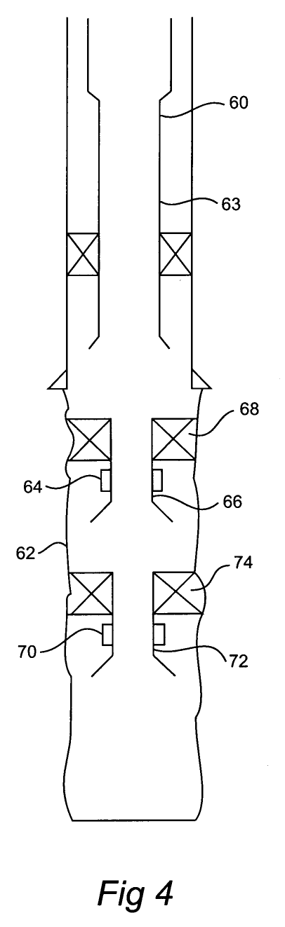

The method and system of data acquisition and transmission in accordance with the invention may also be employed in a wellbore with an open formation as illustrated in FIG. 4. An upper completion 60 extends into an open hole formation 62 in which a second embodiment of data acquisition in accordance with the invention is deployed. The upper completion extends into the open hole formation via a tail pipe 63 with wave guide. A first data acquisition module 64 is mounted in connection with a length of well tubing 66 supported in the formation by an open hole packer 68. A second data acquisition module 70 is mounted in connection with a second length of well tubing 72 supported in the formation by an open hole packer 74. RF signals can still be transmitted over short distances within the open formation 62 from one module 70 to an adjacent module 64 using the wave guide principle.

Microwaves are electromagnetic waves with typical wavelengths of between 30 cm and 1 mm, corresponding to frequencies within the range of about 1 GHz and 300 GHz. Water affects electromagnetic radiation in different ways, depending on the absorption spectrum of the fluid. By utilizing the different absorption properties of the RF and microwave spectrum, the ability to detect water ingress into the well bore tubing is possible. The location and extent of the water ingress can furthermore be determined as a diagnostic aid.

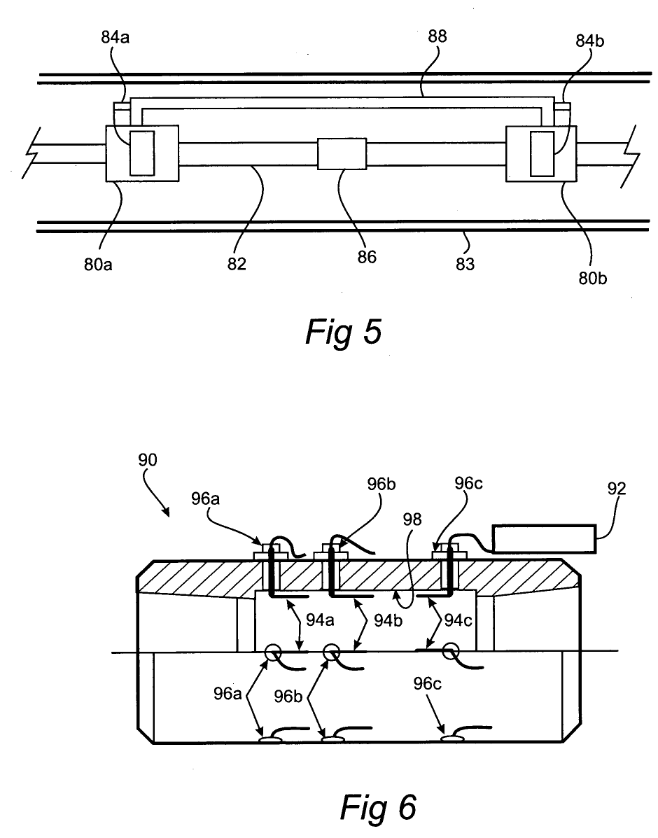

Redundant types and levels of communication are built-in to the system. Should one method of communication fail, an alternate system (for example, acoustic) may be activated. Communication strategies interior and exterior to the wellbore tubing are used to provide for additional coverage over all production fluid types expected in the well. FIG. 5 illustrates one such redundant communication strategy that may be employed in a section of a well bore tubing. A first data acquisition module 80a is positioned in a tubing or liner string 82 within the wellbore casing 83, spaced from a neighbouring data acquisition module 80b a prescribed distance (typically up to several tens of metres). The modules 80a and 80b are in separate lengths of tubing or liner joined by one or more couplings 86.

One or more antennae (not visible) for each of the data acquisition modules 80 extend into the interior of the tubing 82 and data is transmitted using RF or microwave transmission through the fluid flowing in the tubing using the waveguide principle. As previously described, testing has established that data transfer rates of between 10,000 bps and 1.5×10⁶ bps (real time video data streaming) can be achieved through various flow streams of oil, gas and water fluid mixtures. However in the event that the data transmission through the production fluid becomes unreliable due to reservoir fluid composition, an alternate communication strategy is provided via an external fluid-filled (liquid or gas) RF wave guide 88 employed as a control line. Both modules 80a and 80b have a respective external antenna 84a and 84b that extends into the wave guide 88 for data transmission through the control line.

To save power and extend the operational life of the data acquisition system, the transmission between transceivers occurs at precise intervals and times. The system has accurate temperature compensated clocks to provide this timing control. Accuracy of time can be kept within 5 seconds per year at the worst case. At each transmission, the clocks can be reset to provide for minimal timing error for more frequent transmission. Data transmission can be controlled from once per year, once per month, once per week, once per day, to once per minute depending upon system requirements. Transmission data rates can be changed as required, interactively, and can be modified at any time as required.

Advantageously the data acquisition system has the ability to receive and recognize transmission from multiple transceivers and communication methodologies. Each data acquisition module has identifiers that distinguish it individually. It is also capable of recognizing the surrounding modules in the array to aid in redundancy. Error checking is built-in to the communication protocol to provide for error-free transmission. Clever programming of the data acquisition modules will orchestrate smooth data flow and effective power management, by ensuring the following factors are observed:

Transmission protocols

Timing of communications

Clock synchronisation

Error detection and correction

Wake up and sleep modes

Power efficiency

Data processing and storage

The data acquisition modules in accordance with the invention are preferably designed in order to meet the requirements of normal wellbore geometry. The antennae, data transceiver, data processing means and power supply are typically housed in a sub 90, which is similar to a casing or tubing coupling, as illustrated in FIG. 6. The data transceiver, data processing means and power supply of the module are mounted on the exterior of the sub in a protective housing 92. Three sets of three antennae 94 are illustrated, extending through the wall into the interior of the sub 90 through which the production fluid flows (a fourth set is provided on the other side of the sub which is not visible in FIG. 6). Clearly additional or fewer sets of antennae may be deployed as required. A series of sealed ports 96 are provided in the wall of the sub for receiving the antennae 94. The ports 96 are spaced at short intervals longitudinally of the sub 90, as well radially about the circumference of the sub 90. In this embodiment the antennae are positioned in a recess 98 below the internal diameter of the sub. One of the antennae 94 in each set points in the opposite direction to the other two. This arrangement of the antennae 94 is intended to ensure that no matter what orientation the sub 90 might take in the field, it will always be capable of transmitting a signal to an adjacent module.

The downhole power requirements of the data acquisition system are preferably met by improved battery technology, supplemented where possible by downhole power generating and harvesting facilities, such as piezoelectric, vibration and Seebeck effect technology. In some situations a surface power supply may also be used.

Now that preferred embodiments of the method and system of data acquisition have been described in detail, it will be apparent that it provides a number of advantages over the prior art, including the following:
(i) By employing on-board intelligence the data acquisition modules in the system can respond to changes in downhole conditions and control the rate of data acquisition and/or transmission accordingly. This helps to conserve power and minimise data processing, storage and transmission requirements.
(ii) Significantly increased bandwidth can be achieved by using channelled RF or microwave transmission using the waveguide principle, which permits vast amounts of data to be transferred at relatively low power.
(iii) The data acquisition system has the ability to. receive and recognize transmission from multiple transceivers using multiple communication methodologies, so that should one communication medium fail another can be employed to maintain integrity of transmission.

It will be readily apparent to persons skilled in the relevant arts that various modifications and improvements may be made to the foregoing embodiments, in addition to those already described, without departing from the basic inventive concepts of the present invention. For example, whilst the data processing means of the illustrated embodiment employed a microcontroller, with improvements in electronics technology each module may be equipped with its own onboard computer. Therefore, it will be appreciated that the scope of the invention is not limited to the specific embodiments described.

1. A system of data acquisition and transmission in a channel for conveying liquid and/or gas, the system comprising:
one or more of data acquisition modules for acquiring data relating to conditions adjacent the data acquisition module and transmitting the data to a terminal collection station or adjacent data acquisition module via an electromagnetic signal,
wherein the or each downhole data acquisition module is configured to transmit the signal such that an element of the channel adjacent the data acquisition module acts as a waveguide.

2. A system of data acquisition and transmission in accordance with claim 1, wherein the element of the channel acting as a waveguide comprises a wellbore liner.

3. A system of data acquisition and transmission in accordance with claim 1, wherein the element of the channel acting as a waveguide comprises a control line.

4. A system of data acquisition and transmission in accordance with claim 1, wherein the electromagnetic signal comprises an RF or microwave signal.

5. A system of data acquisition and transmission in accordance with claim 4, wherein each data acquisition module includes a tuned coaxial antenna for transmission of data.

6. A system of data acquisition and transmission in accordance with claim 1, wherein each module includes a data processing logic unit responding to changes in conditions and for controlling the rate of data acquisition and/or transmission accordingly, whereby, the volume of data to be transmitted to the terminal collection station is optimised.

7. A system of data acquisition and transmission in accordance with claim 6, wherein the rate of data transmitted is adjusted according to a rate of change of the acquired data.

8. A system of data acquisition and transmission in accordance with claim 1, wherein each data acquisition modules includes one or more data acquisition sensors.

9. A system of data acquisition and transmission in accordance with claim 8, wherein the data acquisition sensors sense parameters including one or more of pressure, temperature, flow rate, noise and conductivity.

10. A system of data acquisition and transmission in accordance with claim 9, wherein the data acquisition modules include an analogue conditioning circuit to convert analogue data received by the sensors to digital data to be provided to the data processing logic unit.

11. A system of data acquisition and transmission in accordance with claim 1, wherein each of the data acquisition modules combines data acquired by that data acquisition module with data received from other data acquisition modules and transmits the combined data to the terminal collection station directly or indirectly via other data acquisition modules.

12. A system of data acquisition and transmission in accordance with claim 11, wherein each of the data acquisition modules performs calculations on the data received from a plurality of data acquisition modules and transmits the results of the calculations to the terminal collection station directly or indirectly.

13. A system of data acquisition and transmission in accordance with claim 1, wherein the frequency of the transmitted signal is tuned based on the properties of the fluid through which the signal is transmitted.

14. A method of data acquisition and transmission in a channel for conveying liquid and/or gas, the method comprising the steps of:
providing one or more of data acquisition modules for acquiring data relating to conditions adjacent the data acquisition module, the or each data acquisition module being configured to transmit the signal such that an element of the channel adjacent the data acquisition module acts as a waveguide; transmitting the data to a terminal collection station or adjacent data acquisition module via an electromagnetic signal.

15. A method of data acquisition and transmission in accordance with claim 14, wherein the element of the channel acting as a waveguide comprises a wellbore liner.

16. A method of data acquisition and transmission in accordance with claim 14, wherein the element of the channel acting as a waveguide comprises a control line.

17. A method of data acquisition and transmission in accordance with claim 14, wherein the signal used is an RF or microwave signal.

18. A method of data acquisition and transmission in accordance with claim 14, including the data processing logic unit responding to changes in conditions and controlling the rate of data acquisition and/or transmission depending on downhole conditions.

19. A method of data acquisition and transmission in accordance with claim 6, wherein the rate of data transmitted is adjusted according to the rate of change of the acquired data.

20. A method of data acquisition and transmission in accordance with claim 14, wherein one or more of pressure, temperature, flow rate, noise and conductivity are sensed by the data acquisition modules.

21. A method of data acquisition and transmission in accordance with claim 14, including the step of the data acquisition modules combining data acquired with data received from other data acquisition modules and transmitting the combined data to the terminal collection station directly or indirectly via other data acquisition modules.

22. A method of data acquisition and transmission in accordance with claim 21 , wherein each of the data acquisition modules performs calculations on the data received from a plurality of data acquisition modules and transmits the results of the calculations to the terminal collection station directly or indirectly.

23. A method of data acquisition and transmission in accordance with claim 14, wherein the frequency of the transmitted signal is tuned based on the properties of the fluid through which the signal is transmitted.

24. A data acquisition module for use in a channel conveying a fluid, the data acquisition module comprising:
a data acquisition logic unit acquiring data relating to conditions adjacent the module; and
a transceiver transmitting the data to a terminal collection station an adjacent data acquisition module via an electromagnetic signal;
wherein the data acquisition module transmits the signal such that an element of the channel adjacent the data acquisition module acts as a waveguide for the signal.

25. A data acquisition module in accordance with claim 24, configured such that the waveguide comprises a wellbore liner.

26. A data acquisition module in accordance with claim 24, configured such that waveguide comprises a control line.

27. A data acquisition module in accordance with claim 24, wherein the electromagnetic signal comprises an RF or microwave signal.

28. A data acquisition module in accordance with claim 24, wherein a tuned coaxial antenna is provided for transmission of data.

29. A data acquisition module in accordance with claim 24, wherein a data processing logic unit responds to changes in conditions and for controlling the rate of data acquisition and/or transmission accordingly, whereby, in use, the volume of data to be transmitted to the terminal collection station is optimised.

30. A data acquisition module in accordance with claim 29 configured such that the rate of data transmitted is adjusted according to the rate of change of the acquired data.

31. A data acquisition module in accordance with claim 24 including one or more data acquisition sensors.

32. A data acquisition module in accordance with claim 31 , wherein the sensors sense parameters including one or more of pressure, temperature, flow rate, noise and conductivity.

33. A data acquisition module in accordance with claim 32 including an analogue conditioning circuit converting analogue data received by the sensors to digital data provided to the data processing logic unit.

34. A data acquisition module in accordance with claim 24 wherein the data acquisition module combines data acquired with data received from other data acquisition modules and transmits the combined data to the terminal collection station directly or indirectly via other data acquisition modules.

35. A data acquisition module in accordance with claim 34, wherein the data acquisition modules performs calculations on the data received from a plurality of data acquisition modules and transmits the results of the calculations to the terminal collection station directly or indirectly.

36. A data acquisition module in accordance with claim 24, wherein the frequency of the transmitted signal is tuned based on the properties of the fluid through which the signal is transmitted.
